(19) United States
(12) Patent Application Publication
(10) Pub. No.: US 2015/0331122 A1
(43) Pub. Date: Nov. 19, 2015

(54) WAVEFORM-BASED SEISMIC LOCALIZATION WITH QUANTIFIED UNCERTAINTY

(71) Applicant: Schlumberger Technology Corporation, Sugar Land, TX (US)

(72) Inventors: Michael David Prange, Somerville, MA (US); Sandip Bose, Chestnut Hill, MA (US); Ousmane Kodio, Cambridge, MA (US); Hugues Djikpesse, Cambridge, MA (US)

(73) Assignee: Schlumberger Technology Corporation, Sugar Land, TX (US)

(21) Appl. No.: 14/280,086

(22) Filed: May 16, 2014

(51) Int. Cl. G01V 1/30

(52) U.S. Cl. CPC G01V 1/305; G01V 2210/70

(57) ABSTRACT

A method, a system, and a computer readable medium for analyzing a wavelet within a seismic signal are described herein. The method includes receiving a seismic signal from a seismic receiver, such as a geophone, and using a Bayesian probability method to determine an associated arrival time for the wavelet and determine an uncertainty for the arrival time of the wavelet. The method has application in hydraulic fracturing monitoring operations and in spatially mapping fractures.

### TECHNICAL FIELD

This disclosure relates to processing seismic data, and more particularly to processing seismic data in order to quantify uncertainty in wavelet arrival time.

### BACKGROUND

Seismic data processing has long been associated with the exploration and development of subterranean resources such as hydrocarbon reservoirs. One example of a procedure that uses seismic data processing is hydraulic fracture monitoring (HFM). Hydraulic fracturing is a stimulation treatment via which reservoir permeability is improved by subjecting a formation adjacent to a portion of a wellbore to increased pressure in order to create and widen fractures in the formation, thereby improving oil and gas recovery. HFM techniques are utilized to evaluate the propagation paths and thickness of the fractures.

Seismic events occur during hydraulic fracture treatment when pre-existing planes of weakness in the reservoir and surrounding layers undergo shear slippage due to changes in stress and pore pressure. The seismic events are also known as “microseismic” events. The resulting microseismic waves can be recorded by arrays of detectors placed in the well undergoing treatment or a nearby monitoring well. However, the recorded seismic waveforms are usually complex wavetrains containing high amplitude noise as well as wellbore waves excited by operation of pumps located at the surface. Consequently, accurately estimating the time of arrival of various recorded events such as P-wave and S-wave arrivals and quantifying uncertainty associated with those arrival times is technologically challenging.

There has been extensive work on seismic event localization that uses time-based methods to analyze event arrival times that have been extracted from waveform data. Most of this work is based on a least-squares fitting of arrival times. More recently, there has been work on waveform-based methods that directly analyze waveform data. The primary advantages of time-based methods over waveform-based methods that directly analyze waveforms are two-fold: (i) location uncertainty can be fully quantified with respect to uncertainty in arrival-time identification and uncertainty in velocity models and (ii) simulated travel times needed for source location inversion can be computed more accurately than the simulated full waveforms needed for full-waveform inversion. The primary advantage of using waveform-based methods is that waveform-based methods avoid issues associated with arrival-time picking and labeling for each seismic phase. The picking and labeling involves correctly identifying all of relevant seismic phases (P-waves, S-waves, . . . ) emitted from a single seismic event across a receiver array and then assigning an arrival-time pick to each phase with quantified uncertainty. Waveform-based methods are also known as beam forming, beam steering, and reverse-time migration.

Waveform-based methods avoid phase picking and labeling issues, but do not provide an accurate estimate of location uncertainty. Waveform-based methods are derived from seismic imaging approaches and typically use image resolution or an estimate of a point-spread function as an indicator of location uncertainty. As is explained below, this approach typically produces a gross overestimation of actual quantified uncertainty. While full-waveform approaches have been presented that fully quantify location uncertainty, these approaches lead to inverse problems that are computationally slow to evaluate and, thus, do not provide timely support in guiding hydrofracturing at a well site.

Another approach is known as relative seismic localization. Relative seismic localization uses previously located seismic source data to improve a location estimate for a nearby seismic event. Examples of relative localization are the interferometric and double-difference methods used in both teleseismic and microseismic location. Such methods have a reduced sensitivity to uncertainty in the velocity model with respect to the uncertainty in seismic source location. In addition to providing improved locations for one source relative to another, the methods can also improve absolute location estimates when location information is available for some of the sources. Relative location methods are time based and, thus, suffer from the same time picking and phase labeling issues as time-based methods for single-event location.

### SUMMARY

Illustrative embodiments of the present disclosure are directed to a method for analyzing a wavelet within a seismic signal. The method includes receiving a seismic signal from a seismic receiver, such as a geophone, and using a Bayesian probability method to determine an associated arrival time for the wavelet and determine an uncertainty for the arrival time of the wavelet. The wavelet can be representative of a P-wave arrival and/or an S-wave arrival.

In various embodiments, the uncertainty in the arrival time for the wavelet is determined using a posterior probability. The posterior probability is a probability of the arrival time given the seismic signal. The wavelet can represented as a reference wavelet shifted in time by a time delay. In some embodiments, the reference wavelet is multiplied by a constant, which is representative of distortion in both amplitude and phase of the reference wavelet.

In a specific embodiment, determining uncertainty in the arrival time using the Bayesian probability method includes determining uncertainty in time delay between (i) a first wavelet within a first seismic signal obtained from a seismic receiver and (ii) a second wavelet within a second seismic signal obtained from the seismic receiver. The first wavelet can be represented by a reference wavelet and the second wavelet can be represented by the reference wavelet multiplied by a constant and shifted in time by the time delay. The uncertainty in the time delay is determined using a posterior probability and the posterior probability is a probability of the time delay given the first seismic signal and the second seismic signal.

In some embodiments, the method can be used to determine a probability for a location of a seismic source. The method includes using the Bayesian probability method to determine uncertainty in arrival time for each of a number of wavelets within a number of seismic signals obtained from a number of seismic receivers. The probability for location of a seismic source is determined using uncertainty in arrival time for each of the wavelets. Probabilities for a number of potential locations for the seismic source are determined using a seismic travel-time function that determines travel time for each wavelet from a potential seismic source location to a seismic receiver. The condition for determining the probability of a potential source location is that the wavelets from each of the receivers align at a correct seismic source location.

In another embodiment, the method can determine a probability for a location of a seismic source using uncertainty in time delay between an arrival time for a first wavelet and an arrival time for a second wavelet. The method includes using the Bayesian probability method to determine (i) uncertainty in arrival time for the first wavelet within a seismic signal obtained from a seismic receiver and (ii) uncertainty in arrival time for the second wavelet within the seismic signal obtained from the seismic receiver. In some cases, the first wavelet is representative of a P-wave and the second wavelet is representative of an S-wave. The probability for the seismic source location can be determined using a seismic travel-time function that determines (i) travel time for the P-wave from a potential seismic source location to the seismic receiver and (ii) travel time for the S-wave from a potential seismic source location to the seismic receiver. The condition for determining the probability of a potential source location is that the P-wave and the S-wave align at a correct seismic source location.

In yet another embodiment, the method can determine a probability for a location of a seismic source using a different seismic source with a known location. The method includes using the Bayesian probability method to determine uncertainty in arrival time for a first wavelet and uncertainty in arrival time for a second wavelet within a seismic signal obtained from a seismic receiver. The first wavelet is generated by a first seismic source with a known location and the second wavelet is generated using a seismic source with an unknown location. The probability for the location of the second seismic source can be determined using uncertainty in time delay between the arrival time for the first wavelet and the arrival time for the second wavelet. The probability for the second seismic source location is determined using a seismic travel-time function that determines travel time for the second wavelet from a potential second seismic source location to the seismic receiver.

In a further embodiment, the method includes using the Bayesian probability method to determine uncertainty in time delay for a number of wavelets in a number of seismic signals obtained from a number of seismic receivers. The uncertainty in time delay for the wavelets is used to determine locations for the seismic sources with associated uncertainties. The locations for the seismic sources are then used to spatially map fractures during a hydraulic fracturing operation.

Various embodiments of the present disclosure are also directed to system for analyzing a wavelet in a seismic signal. The system includes a processing system that (i) receives a seismic signal and (ii) uses a Bayesian probability method to determine uncertainty in arrival time for a wavelet in the seismic signal. The system may also include an array of seismic receivers. The receivers can be deployed in a wellbore and/or at a surface location.

Illustrative embodiments of the present disclosure are directed to a non-transitory computer readable medium encoded with instructions, which, when loaded on a computer, establish processes for analyzing a wavelet in a seismic signal. The processes include using a Bayesian probability method to determine uncertainty in arrival time for a wavelet in the seismic signal.

### BRIEF DESCRIPTION OF THE DRAWINGS

Those skilled in the art should more fully appreciate advantages of various embodiments of the present disclosure from the following “Description of illustrative Embodiments” discussed with reference to the drawings summarized immediately below.

FIG. 1 shows a method for analyzing a wavelet within a seismic signal in accordance with one embodiment of the present disclosure;

FIG. 2 shows a hydraulic fracture monitoring (HFM) operation in accordance with one embodiment of the present disclosure;

FIG. 3A shows a wavelet;

FIG. 3B shows a noisy signal;

FIG. 3C shows a correlation function determined from the noisy signal in FIG. 3B;

FIG. 3D shows a posterior probability for time delay determined from the noisy signal in FIG. 3B in accordance with one embodiment of the present disclosure;

FIG. 4 shows a comparison between a histogram of time delay values corresponding to the peak of the correlation curve from FIG. 3C and the posterior probability from FIG. 3D;

FIG. 5A shows a wavelet;

FIG. 5B shows a noisy signal;

FIG. 5C shows a correlation function determined from the noisy signal in FIG. 5B;

FIG. 5D shows an envelope for the correlation function in FIG. 5C;

FIG. 5E shows a posterior probability for time delay determined from the noisy signal in FIG. 5B in accordance with one embodiment of the present disclosure;

FIG. 6 shows a comparison between a histogram of time delay values corresponding to the peak of the envelope in FIG. 5D and the posterior probability from FIG. 5E;

FIGS. 7A and 7B shows two noisy signals;

FIG. 7C shows an envelope for a correlation function determined from the two noisy signals shown in FIGS. 7A and 7B without filtering;

FIG. 7D shows a posterior probability for time delay determined from the two noisy signals shown in FIGS. 7A and 7B without filtering in accordance with one embodiment of the present disclosure;

FIG. 7E shows an envelope for a correlation function determined from the two noisy signals shown in FIGS. 7A and 7B with filtering;

FIG. 7F shows a posterior probability for time delay determined from the two noisy signals shown in FIGS. 7A and 7B with filtering in accordance with one embodiment of the present disclosure;

FIG. 8 shows a comparison between a histogram of time delay values corresponding to the peak of the envelope of the correlation curve from FIG. 7E and the posterior probability from FIG. 7F;

FIG. 9A shows a source location and associated confidence region that were determined using a posterior probability and known source initiation time in accordance with one embodiment of the present disclosure;

FIG. 9B shows signals received at each of eleven seismic receivers in accordance with one embodiment of the present disclosure;

FIG. 10 shows a source location and associated confidence region that were determined using a posterior probability and an unknown source initiation time in accordance with one embodiment of the present disclosure;

FIG. 11A shows a source location and associated confidence region that were determined using a posterior probability with unknown source initiation and multiple seismic phases in accordance with one embodiment of the present disclosure;

FIG. 11B shows a vertical component of a signal received at each of the eleven two-component seismic receivers in accordance with one embodiment of the present disclosure;

FIG. 12 shows a source location and associated confidence region that were determined using a posterior probability and time delay between S-waves and P-waves in accordance with one embodiment of the present disclosure;

FIG. 13A shows a source location and an associated confidence region that were determined using a relative source location in accordance with one embodiment of the present disclosure;

FIG. 13B shows a system configuration in accordance with one embodiment of the present disclosure in accordance with one embodiment of the present disclosure;

FIG. 14A shows 95 percent confidence regions for ten different velocity models determined using a S-wave minus P-wave method in accordance with one embodiment of the present disclosure;

FIG. 14B shows 95 percent confidence regions for ten different velocity models determined using a relative source location method in accordance with one embodiment of the present disclosure; and

FIG. 14C shows a comparison between the 95 percent confidence regions for the S-wave minus P-wave method of FIG. 14A and the relative source location method of FIG. 14B.

### DESCRIPTION OF ILLUSTRATIVE EMBODIMENTS

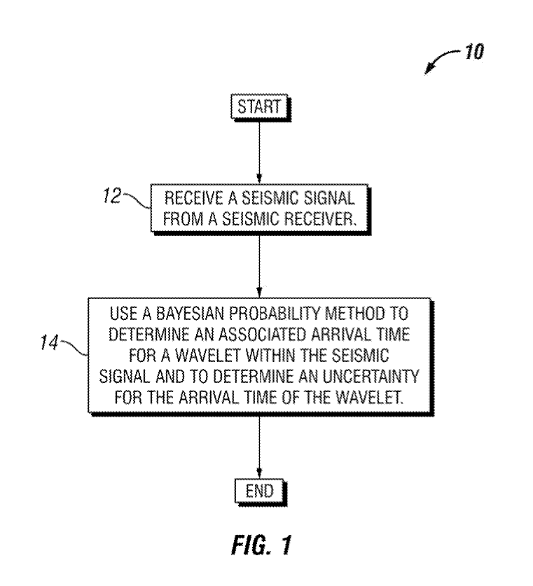

Illustrative embodiments of the disclosure are directed to a method, a system, and a computer readable medium for analyzing a wavelet within a seismic signal. FIG. 1 shows a method 10 for analyzing a wavelet within a seismic signal. The method includes receiving a seismic signal from a seismic receiver 12, such as a geophone. The method further includes using a Bayesian probability method to determine an associated arrival time for the wavelet and determine an uncertainty for the arrival time of the wavelet 14. By applying the Bayesian probability method to the seismic signal (e.g., waveform data), various embodiments of the method described herein avoid the picking and labeling issues involved with the time-based methods described above, while also providing time-efficient and accurate estimates of location uncertainty for arrival time and source location. Details of various embodiments are described below.

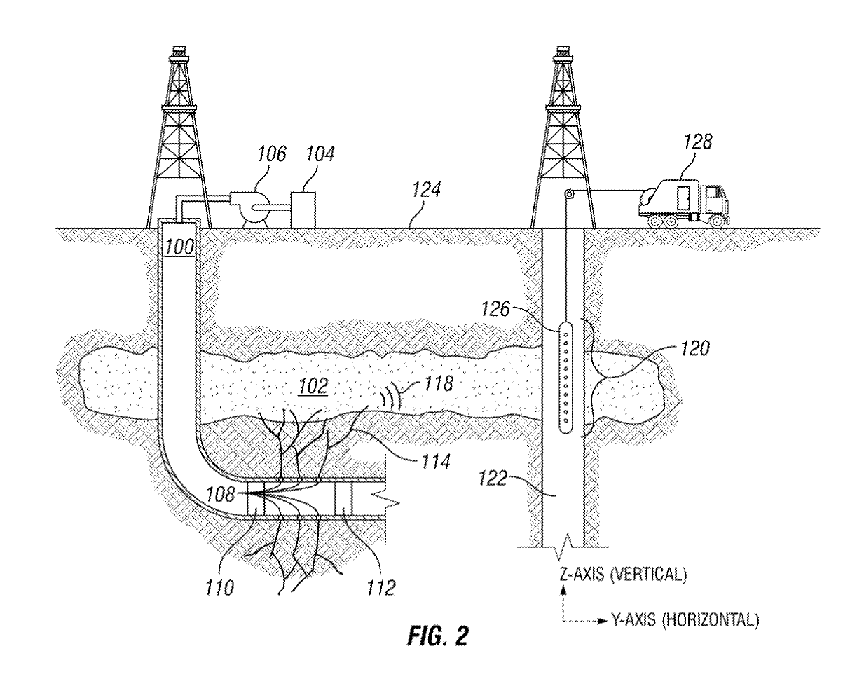

FIG. 2 shows a hydraulic fracture monitoring (HFM) operation in accordance with one embodiment of the present disclosure. The method described herein can be used to analyze the seismic data obtained from the HFM operation. The HFM operation includes performing a hydraulic fracturing operation in a treatment wellbore 100 that traverses a formation 102. The fracturing operation is performed by pumping a treatment fluid into the wellbore from a surface reservoir 104 using a pump 106. The treatment fluid communicates with the formation through a series of perforations 108. The treatment fluid may be hydraulically confined to a particular portion of the wellbore by using packers (110 and 112). For example, if the wellbore includes a completion with packers, then some or all of the perforations 108 in a particular area may be hydraulically isolated from other portions of the wellbore so that the fracturing treatment is performed on a particular portion of the formation 102. In order to implement the treatment, the pressure of the treatment fluid is increased using the pump. The communication of that increased pressure to the formation creates new fractures and widens existing fractures (collectively, fractures 114 in the formation).

The hydraulic fracturing treatment described above causes seismic events to occur. In the context of a fracturing operation, the seismic events are also referred to as “microseisms” or “microseismic events.” The seismic events generate seismic waves 118 that are emitted when pre-existing planes of weakness in the reservoir and surrounding layers undergo shear slippage due to changes in stress and pore pressure. The emitted seismic waves 118 are recorded by an array of multicomponent seismic receivers 120, such as geophones, that are placed within the treatment wellbore 100, a monitoring wellbore 122, and/or at the surface 124. In this example, the array of seismic receivers 120 is part of a wireline tool 126 placed inside the monitoring wellbore 122. The seismic waves are detected by the array 120 and are processed by a hydrophone digitizer, recorder, and a processing system in order to monitor the hydraulic fracturing treatment. The hydrophone digitizer, recorder, and processing system can be part of surface equipment 128 that supports the wireline tool 126. The seismic waves detected by the array 120 can be used to monitor the creation, migration and change in fractures in terms of both location and volume. For example, the seismic waves can be used to spatially map the fractures produced by the hydraulic fracturing treatment. The information obtained by monitoring may then be used to help control aspects of the fracturing treatment, such as pressure changes and fluid composition, and also to determine when to cease the treatment. Further details regarding applications for seismic data processing can be found in U.S. Patent Application Publication 2010/0228530, published on Sep. 9, 2010, which is incorporated herein by reference in its entirety.

As explained above, the seismic waves are received at each seismic receiver in the array of receivers. The waves are represented as wavelets within the seismic signals obtained at each seismic receiver. The method described herein uses a Bayesian probability method to determine an associated arrival time for the wavelet and determine an uncertainty for the arrival time of the wavelet. The arrival time for the wavelet and delay time for corresponding wavelets at other seismic receivers can be used to determine seismic event location (e.g., seismic source location). The seismic event location often corresponds to fracture propagation during a hydraulic fracturing operation. Accordingly, quantification of uncertainty for the arrival time of the wavelet is beneficial because it can then be used to determine uncertainty associated with the seismic event location and fracture location.

A Bayesian probability method is any mathematical method that uses Bayes' rule to convert observed information about a system to a probability of one or more parameters of the system. Further details regarding Bayesian probability methods are provided in D. S. Sivia, Data Analysis: A Bayesian Tutorial (Oxford Science Publications 2d ed.) (2006).

Details of quantifying uncertainty in arrival time and seismic event location using the Bayesian probability method are described below. The wavelet received at the seismic receiver can be represented as a reference wavelet shifted in time by a time delay. The reference wavelet is a time-domain wavelet of shape w(t) that is emitted at t=0 from a seismic event. In this example, the seismic signal s(t) received at the receiver can be represented as a time-shifted wavelet plus noise: s(t), w(t−τ)+n(t), where n(t) represents additive noise. The following description assumes that the seismic signals are digitally recorded as N discrete time samples with uniform sampling, but the embodiments described herein are not limited to this sampling. The digitized versions of s(t), w(t) and n(t) are denoted by the N-length vectors s, w and n. The samples of n are drawn from the normal distribution N(0,σ²).

As used herein, the “arrival time” of a wavelet is the time at which the wavelet is recorded at a receiver location. “Time delay” (τ) is the time shift to apply to the reference wavelet w such that it best matches the wavelet in the receiver signal s. The time delay is related to the arrival time and equals the arrival time minus the time of a first sample of the signal vector s. As used herein, the “travel time” (T) is the time needed for a wavelet to travel from a source location to a receiver location.

A Bayesian probability method is used to estimate the uncertainty of the time delay τ from the seismic signal s. The uncertainty of the time delay is identified by determining a posterior probability. The posterior probability is a probability of the time delay given the seismic signal. In vector notation, the signal is modeled by s=w(τ)+n. The notation w(τ) indicates that the reference wavelet w has been time-shifted later in time by a time delay τ using a periodic boundary condition. The likelihood of s conditional on τ for independent identically-distributed (IID) Gaussian noise is given by:

$$p ( s \vert τ ) = \frac{1}{{( 2 {πσ}^{2} )}^{\frac{N}{2}}} exp [ - \frac{1}{2 {σ}^{2}} {‖ s - w ( τ ) ‖}^{2} ] . \qquad ( 1 )$$

For probability notation, the symbol p(•) denotes a probability density function (pdf) that is influenced by measurements, such as a likelihood or a posterior, while pₒ (•) denotes a prior. The notation for conditional probability density p(s|τ) denotes a pdf on s conditional on τ. The norm in equation 1 and elsewhere is the L₂ norm, defined by ∥ε∥²=ε^{H}ε, where the superscript ‘H’ indicates the conjugate transpose. The description uses a notation suitable for complex numbers because, even though the signals in equation 1 are real, later expressions will involve complex analytic signals and signals in the frequency domain.

Letting p₀(τ) represent the prior distribution on τ, the posterior distribution on τ is given by Bayes' rule as:

$$p ( τ \vert s ) = \frac{1}{p ( s )} p ( s \vert τ ) {p}_{0} ( τ ) . \qquad ( 2 )$$

The constant p(s) goes by the names of marginal likelihood and Bayesian evidence in the Bayesian literature, and is given by:

p(s)=∫_{-∞}^{∞}p(s|τ)p₀(τ)dτ. (3)

Expanding the squared norm in the likelihood function, the posterior simplifies to:

$$p ( τ \vert s ) = \frac{1}{p ( s ) {( 2 {πσ}^{2} )}^{\frac{N}{2}}} exp [ - \frac{1}{2 {σ}^{2}} ( {‖ s ‖}^{2} + {‖ w ( τ ) ‖}^{2} - 2 [ s * w ] ( τ ) ) ] {p}_{0} ( τ ) ∝ exp [ \frac{[ s * w ] ( τ )}{{σ}^{2}} ] {p}_{0} ( τ ) , \qquad ( 4 )$$

where the second expression was simplified by folding the factors independent of τ into a proportionality constant.

The notation [s*w](τ) in Equation 4 is used to express a correlation function with time delay τ. Equation 4 provides an exact expression for the posterior arrival-time estimate, including its uncertainty. This expression contains the arrival-time information that can be extracted from the signal s consistent with the assumptions on signal and noise. The correlation term is significant because correlation is often used in seismic imaging as an “imaging condition” that indicates the correct location of the source wavelet in the imaged signal. The peak of this correlation is an unbiased estimator of time delay τ. However, equation 4 proves that, under the above assumptions, the imaging condition that correctly extracts from the signal both the travel-time information and its uncertainty is a weighted exponential of this function. The prior on time delay τ can then be used to incorporate supplemental information.

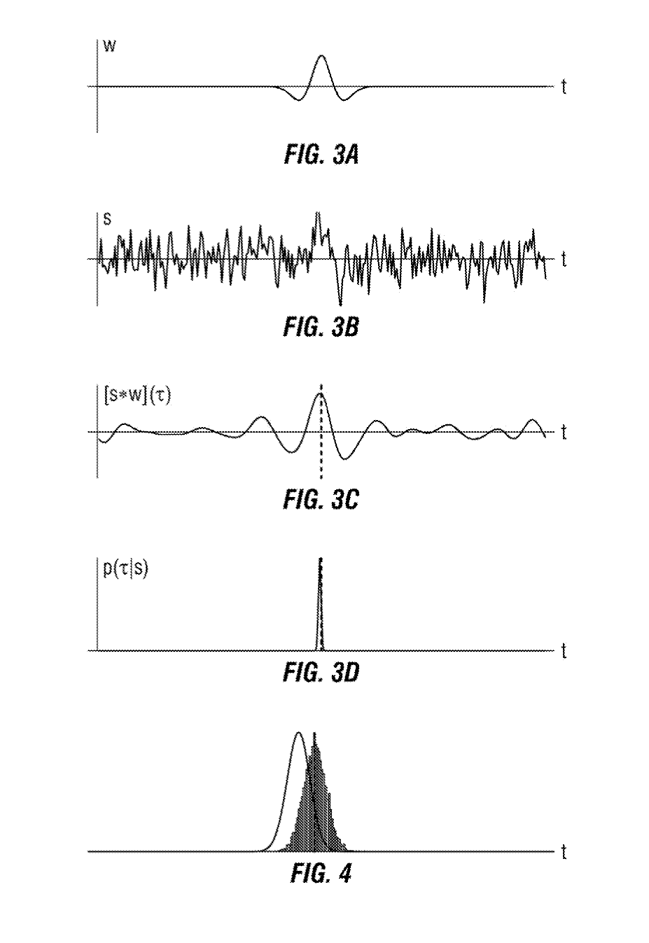

FIG. 3D shows a posterior probability for time delay determined from a noisy signal. FIG. 3A shows a Ricker wavelet with a maximum amplitude of one and FIG. 3B shows the noisy signal that was generated by combining the Ricker wavelet with Gaussian noise (σ=0.5). FIG. 3C shows a correlation function [s*w](τ) that was determined from the noisy signal. The true value of time delay τ is indicated by a vertical line. The correlation function has a peak near the correct target delay. In the absence of noise, the location of the correlation peak will determine the correct target delay. However, with a noisy signal, the location of the correlation peak becomes an unbiased estimator of the delay. It might be tempting to use the width of the correlation peak as an estimate of the uncertainty in time delay τ, but this width is simply a reflection of the bandwidth of the wavelet and is not direct indicator of uncertainty. The posterior probability p(τ|s) for time delay in FIG. 3D was determined from the noisy signal using equation 4. The Figure shows a much narrower peak than the correlation peak and is indicative of the true uncertainty of the time delay.

FIG. 4 compares a histogram of time delay τ values corresponding to the peak of the correlation curve [s*w](τ) from FIG. 3C with the posterior probability from FIG. 3D. The histogram was derived from 10⁴ noise realizations. The posterior probability p(τ|s) from FIG. 3D is repeated at an enlarged scale for comparison. FIG. 4 shows that the posterior uncertainty shown in FIG. 3D is indeed a reasonable estimation of posterior probability p(τ|s). The time scale is magnified from that used in FIG. 3D in order to highlight their differences. The true value of time delay τ is indicated by a vertical line. The peak of the histogram correctly captures the true value. This confirms that the correlation peak is an unbiased estimate of time delay τ. The posterior p(τ|s) is derived from a single noise realization, not the 10⁴ realizations used in the histogram estimate, and thus the true value does not lie at its peak. However, the uncertainty estimate captured by the posterior does possess the correct width, as compared with the histogram, and contains the true value within its probable region. This example demonstrates that the posterior estimator provided by equation 4 accurately describes the target-delay information contained within the noisy signal. Furthermore, it is clear from FIGS. 3A-3D that the width of the correlation peak is a poor estimator of this uncertainty.

For many seismic applications, the source wavelet may be altered in both amplitude and phase by mechanisms, such as source radiation patterns, geometric spreading, attenuation, scattering, reflection, and transmission. A constant can be used to account for additional degrees of freedom in the analysis. For example, the reference wavelet can be multiplied by a constant that allows the noise-free signal to differ by a constant factor in both amplitude and phase. This use of a constant factor is valid when the source wavelet is fairly well known and the distortions to the wavelet along the propagation path are non-dispersive.

The description below uses a frequency-domain representation of the signals and denotes them by \tilde{s}, \tilde{w} and ñ. In various embodiments, these vectors contain only the positive frequency components. The negative frequency components contain no new information because the negative components are simply the complex conjugates of their positive counterparts for real time-domain signals. The zero-frequency component is omitted because it does not contribute to the uncertainty estimate and can be taken as zero with no loss of generality. In the transformation from time to frequency, the formulas below use a positive sign in the phase term of the fast Fourier transform (FFT) and a normalization of 1\sqrt{N}.

In the frequency domain, the measured signal can be represented as:

\tilde{s}=γ\tilde{w}(τ)+ñ, (5)

where the complex constant γ represents a distortion in the wavelet of both amplitude and phase. By Rayleigh's Theorem, the likelihood in the frequency domain has the same form in the time domain, but with γ as an additional factor:

$$p ( \overline{s} \vert τ , γ ) = \frac{1}{b} exp [ - \frac{{‖ \overline{s} - γ \overline{w} ( τ ) ‖}^{2}}{{σ}^{2}} ] , \qquad ( 6 )$$

where the reference wavelet time shift \tilde{w}(τ) is implemented by multiplying the spectral components by a complex phase factor, i.e., each element of \tilde{w} is phase shifted by exp(γωτ), where w is the angular frequency of that element. b is a normalization constant that ensures that the pdf integrates to unity. In the following description, the scaling factor is omitted for notational convenience, and instead each pdf is written as a proportionality. A comparison of equation 1 with equation 6 shows that equation 6 lacks a factor of two dividing the norm. This is a direct result of Rayleigh's theorem, which states that the signal power in the time domain equals that of its power in the frequency domain over both positive and negative frequencies. Since the negative frequencies are omitted in the vector notation herein, the time-domain power in the notation herein is twice that in the frequency domain.

Applying Bayes' rule to this likelihood with the priors p(τ) and p(γ) yields:

$$p ( τ , γ \vert \overline{s} ) ∝ exp [ - \frac{{‖ \overline{s} - γ \overline{w} ( τ ) ‖}^{2}}{{σ}^{2}} ] p ( τ ) p ( γ ) . \qquad ( 7 )$$

Treating γ as a nuisance parameter, the desired result can be found through marginalization. In other embodiments, the value for γ can be accounted for by optimization of a posterior probability function and/or optimization of a maximum likelihood function. The marginalization integral can be analytically evaluated when p(γ) is a member of the exponential family of distributions. The most common situation is considered in this example, where no prior information is available on γ, leading to a constant prior on γ. In this case, the marginalized posterior on τ is given by:

$$p ( τ \vert \overline{s} ) ∝ p ( τ ) \int {\int }_{- ∞}^{∞} exp [ - \frac{{‖ \overline{s} - γ \overline{w} ( τ ) ‖}^{2}}{{σ}^{2}} ] d {γ}^{( r )} d {γ}^{( i )} = \frac{{πσ}^{2}}{{‖ \overline{w} ‖}^{2}} exp [ \frac{\vert {\overline{s}}^{H} \overline{w} ( τ ) {\vert}^{2} - {‖ \overline{s} ‖}^{2} {‖ \overline{w} ‖}^{2}}{{σ}^{2} {‖ \overline{w} ‖}^{2}} ] p ( τ ) ∝ exp [ \frac{\vert {\overline{s}}^{H} \overline{w} ( τ ) {\vert}^{2}}{{σ}^{2} {‖ \overline{w} ‖}^{2}} ] p ( τ ) , \qquad ( 8 )$$

where γ=γ^{(r)}+rγ⁽ⁱ⁾. The third expression in equation 8 has been simplified by folding terms not dependent on time delay τ into the constant of proportionality.

In many of the applications, it is numerically more efficient to evaluate equation 8 in the time domain. The time-domain expressions are given by:

$$p ( τ \vert s ) = p ( τ \vert \tilde{s} ) ∝ \frac{{πσ}^{2}}{‖ w {‖}^{2}} exp [ \frac{\vert 𝒜 [ s * w ] ( τ ) {\vert}^{2} - ‖ s {‖}^{2} ‖ w {‖}^{2}}{2 {σ}^{2} ‖ w {‖}^{2}} ] p ( τ ) ∝ exp [ \frac{\vert 𝒜 [ s * w ] ( τ ) {\vert}^{2}}{2 {σ}^{2} ‖ w {‖}^{2}} ] p ( τ ) ∝ exp [ \frac{{ɛ}^{2} [ s * w ] ( τ )}{2 {σ}^{2} ‖ w {‖}^{2}} ] p ( τ ) , \qquad ( 9 )$$

where [symbol] [s*w](τ) is the analytic signal corresponding to the time-domain correlation function [s*w](τ). The analytic signal is complex extension of a real signal defined by [symbol] [ε](τ)=ε(τ)− [symbol] [ε](τ), where [symbol] [ε] is the Hilbert transform of ε. A derivation of the equivalence 2\tilde{s}^{H}\tilde{w}(τ)= [symbol] [s*w](τ) is given in Appendix A below. The magnitude of the analytic signal defines the signal envelope, denoted by ε[•](τ). Hence, the modification of equation 4 removes the effect of unknown wavelet amplitude phase to replace the correlation function with the normalized square of the correlation envelope.

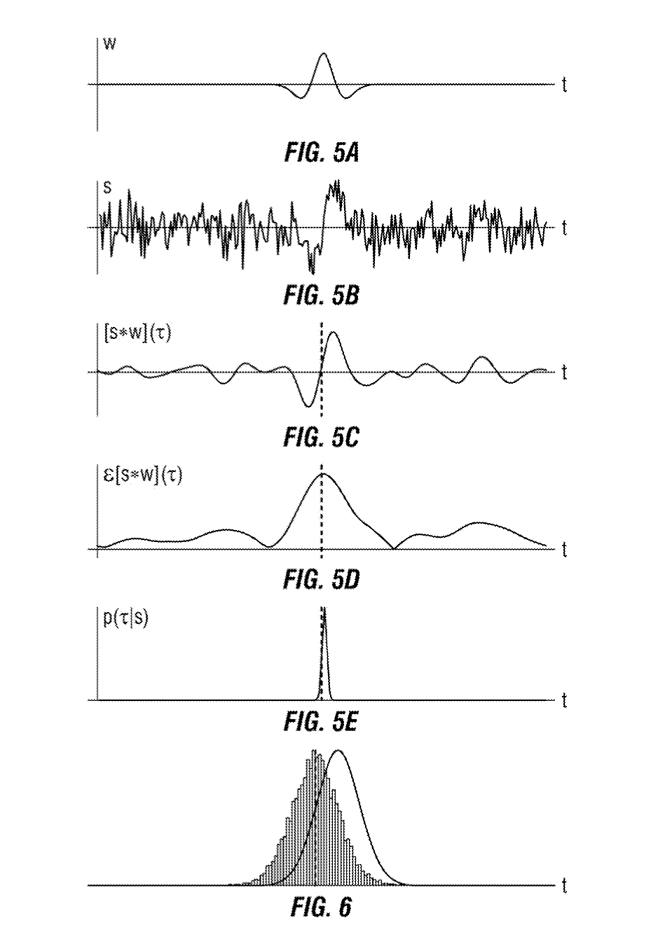

FIG. 5E shows a posterior probability for time delay determined from a noisy signal. The posterior probability was determined using equation 9. The Ricker wavelet and the noisy signal are plotted in FIGS. 5A and 5B, respectively. The wavelets of both signals are centered on the time axis. The noisy signal in FIG. 5B is formed from equation 5 using the same wavelet and noise levels as FIGS. 3A-3B. The amplitude and phase distortion for s is chosen as γ=1.5 exp(ιπ/2). FIG. 5C shows a correlation of the signal with the wavelet determined from the signal and FIG. 5D shows an envelope for the correlation function. The τ=0 location is indicated by a vertical line. The π/2 phase shift of the signal s relative to the wavelet w is readily apparent in the correlation function. Although τ=0 is the true value of the correlation lag, the correlation function is nearly zero there. The maximum correlation magnitudes lie adjacent to this value. This effect is a well-known occurrence when using a correlation-based imaging condition for microseismic source location. An unbiased estimator of time delay τ is given by the peak of the envelope of the correlation function, as shown in FIG. 5D. This removes the effect of phase distortion. The width of this peak is a poor indication of the uncertainty in the time delay τ estimate. This may be seen by comparison with the plot of the posterior probability p(τ|s) provided in FIG. 5E.

FIG. 6 compares a histogram of time delay τ values corresponding to the peak of the envelope of the correlation curve [s*w](τ) from FIG. 5D with the posterior probability from FIG. 5E. The histogram uses the peak of the envelope of the correlation function as an unbiased estimator of time delay τ. The histogram was derived from 10⁴ noise realizations. FIG. 6 shows that the posterior probability p(τ|s), as given by equation 9, is an accurate estimator of the uncertainty on time delay τ. The posterior probability p(τ|s) from FIG. 5E is overlain at the same scale for comparison. The peak of the histogram lies at the true value, indicating that the correlation envelope is an unbiased estimator. By comparison with this estimator, the distribution of equation 9, which is created from a single realization of the noisy signal, contains the true value of time delay τ as a probable value and provides a good estimate of the uncertainty in time delay τ. The uncertainty in time delay τ, derived through γ marginalization, is clearly larger than that derived from comparing a single noisy signal to a known wavelet. That being said, the uncertainty estimate given by equation 9 is clearly smaller than the one provided by the width of the envelope of the correlation peak.

Illustrative embodiments of the present disclosure are also directed to methods for extracting time delay from two or more noisy signals obtained from a seismic receiver. This method can be applied to relative source localization, where signals from two different sources are compared at a single receiver (within the array). The first signal \tilde{s}₁ and the second signal \tilde{s}₂ can be described in terms of a common wavelet w subject to a constant distortion in amplitude and phase described by the coefficients β₁ and β₂. Without loss of generality, the delay time between the two signals can be written as: \tilde{s}₁=β₁\tilde{w}(0)+ñ₃ and \tilde{s}₂=β₂\tilde{w}+ñ₂ with nⱼ=N(0, σⱼ²), jε{1,2}.

Following the form of the likelihood function given in equation 7, the likelihood function for s₁ and s₂ can be written as:

$$p ( {\tilde{s}}_{1} , {\tilde{s}}_{2} \vert τ , {γ}_{1} , {γ}_{2} ) ∝ exp [ - \frac{‖ {γ}_{1} {\tilde{s}}_{1} - {γ}_{2} {\tilde{s}}_{2} ( τ ) {‖}^{2}}{\vert {γ}_{1} {\vert}^{2} {σ}_{1}^{2} + \vert {γ}_{2} {\vert}^{2} {σ}_{2}^{2}} ] , \qquad ( 10 )$$

where the coefficients γ₁ and γ₂ remove the distortions in \tilde{w} induced by β₁ and β₂. The following additional constraint is also imposed:

|γ₁|²+|γ₂|²=1, (11)

in order to resolve the scaling ambiguity in γ₁ and γ₂. Applying Bayes' rule, with p(τ) as the prior for the time delay and using, as before, a constant prior for γ₁ and γ₂, subject to the constraint in equation 11, the joint posterior for τ, γ₁ and γ₂ can be written as:

$$p ( τ , {γ}_{1} , {γ}_{2} \vert {\tilde{s}}_{1} , {\tilde{s}}_{2} ) ∝ exp [ - \frac{‖ {γ}_{1} {\tilde{s}}_{1} - {γ}_{2} {\tilde{s}}_{2} ( τ ) {‖}^{2}}{\vert {γ}_{1} {\vert}^{2} {σ}_{1}^{2} + \vert {γ}_{2} {\vert}^{2} {σ}_{2}^{2}} ] p ( τ ) . \qquad ( 12 )$$

Once again, treating γ₁ and γ₂ as nuisance parameters, the desired result is found through marginalization. Making the substitutions γ₁=cos(θ)e^{|φ|}and γ₁=sin(θ)e^{1φ2} for

$$0 \leq θ \leq \frac{pi}{2}$$

and 0≦{φ₁, φ₂}<2π, serves to enforce the constraint in equation 11, yielding the marginalization integral:

$$p ( τ \vert {\tilde{s}}_{1} , {\tilde{s}}_{2} ) ∝ p ( τ ) {\int }_{0}^{π / 2} d θ \int {\int }_{0}^{2 π} d {φ}_{1} d {φ}_{2} exp [ - \frac{‖ cos ( θ ) {\tilde{s}}_{1} - sin ( θ ) {e}^{i ( {φ}_{2} - {φ}_{1} )} {\tilde{s}}_{2} ( τ ) {‖}^{2}}{{cos}^{2} ( θ ) {σ}_{1}^{2} + {sin}^{2} ( θ ) {σ}_{2}^{2}} ] . \qquad ( 13 )$$

While equation 13 cannot be fully evaluated analytically, the equation can be reduced to a one-dimensional integral over θ. Expanding the norm in equation 13, the integral can be factored into:

$$p ( τ \vert {\tilde{s}}_{1} , {\tilde{s}}_{2} ) ∝ p ( τ ) {\int }_{0}^{π / 2} d θexp [ - \frac{{cos}^{2} ( θ ) ‖ {\tilde{s}}_{1} {‖}^{2} + {sin}^{2} ( θ ) ‖ {\tilde{s}}_{2} {‖}^{2}}{{cos}^{2} ( θ ) {σ}_{1}^{2} + {sin}^{2} ( θ ) {σ}_{2}^{2}} ] \times \int {\int }_{0}^{2 π} d {φ}_{1} d {φ}_{2} exp [ - \frac{sin ( 2 θ ) R e ( {e}^{i ( {φ}_{2} - {φ}_{1} )} {\tilde{s}}_{2}^{H} {\tilde{s}}_{2} ( τ ) )}{{cos}^{2} ( θ ) {σ}_{1}^{2} + {sin}^{2} ( θ ) {σ}_{2}^{2}} ] , \qquad ( 14 )$$

where Rc(•) extracts the real part of its complex argument. The integrals over φ₁ and φ₂ can be analytically evaluated, yielding:

$$p ( τ \vert {\tilde{s}}_{1} , {\tilde{s}}_{2} ) ∝ 4 {π}^{2} p ( τ ) {\int }_{0}^{π / 2} exp [ - \frac{{cos}^{2} ( θ ) ‖ {\tilde{s}}_{1} {‖}^{2} + {sin}^{2} ( θ ) ‖ {\tilde{s}}_{2} {‖}^{2}}{{cos}^{2} ( θ ) {σ}_{1}^{2} + {sin}^{2} ( θ ) {σ}_{2}^{2}} ] \times {I}_{0} ( - \frac{sin ( 2 θ ) \vert {\tilde{s}}_{2}^{H} {\tilde{s}}_{2} ( τ ) \vert}{{cos}^{2} ( θ ) {σ}_{1}^{2} + {sin}^{2} ( θ ) {σ}_{2}^{2}} ) d θ , \qquad ( 15 )$$

where I₀(ε) is the modified Bessel function of the first kind.

In other embodiments, the values for γ₁ and γ₂ can be accounted for by optimization of a posterior probability function and/or optimization of a maximum likelihood function.

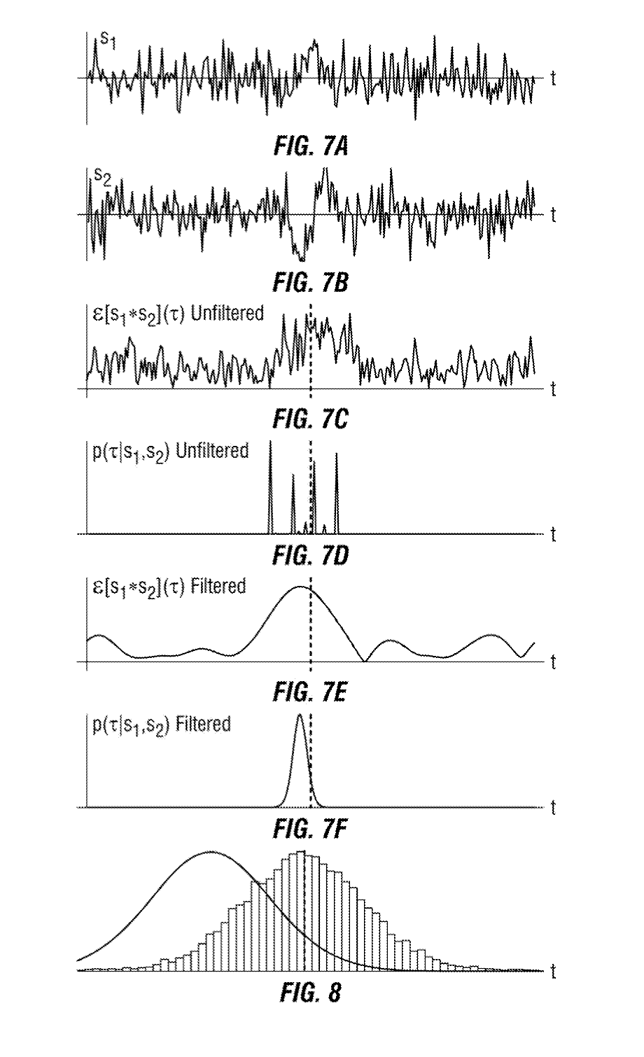

FIG. 7F shows the posterior probability for time delay determined from two noisy signals, as shown in FIGS. 7A and 7B. The posterior probability was determined using equation 15. The two noisy signals were formed using the same wavelet and noise levels as FIGS. 3A-3B. The amplitude and phase distortion for the wavelet in s₂ is chosen as γ=1.5 exp(1π/2). The wavelets of both signals are centered on the time axis. The envelope of the correlation function ε[s₁*s₂](τ) is plotted in FIG. 7C for the unfiltered signals, with a vertical line indicating the true time delay value at τ=0. The posterior for the unfiltered signals p(τ|s₁, s₂) is plotted in FIG. 7D, as computed by equation 15. Note the presence of several spurious peaks. The envelope of the correlation function for filtered signals is plotted in FIG. 7E, and the corresponding posterior, computed from equation 15, is plotted in FIG. 7E. FIGS. 7D and 7E illustrate the value of filtering the signals before using them to compute the posterior uncertainty. The unfiltered signals contain noise throughout the spectrum, while the wavelet is occupying only the lowest eighth of the spectrum, meaning that noise outside of the wavelet band is contributing significantly to the correlation. The posterior is contaminated by its attempt to fit the noise. This is portrayed by the “spiky” nature of the posterior presented in FIG. 7D. This was not an issue in FIGS. 3A-3D and FIGS. 5A-5E because the noisy signal was correlated with a noise-free wavelet, in which case, the out-of-band noise is multiplied by the zeroes in the wavelet spectrum. In the current example, both signals are noisy, so no such filtering naturally occurs. To avoid contamination from out-of-band noise, the signals can be filtered using a filter. In FIGS. 7E and 7F the signals were filtered by a simple low-pass boxcar filter designed to pass 99 percent of the wavelet energy. The envelope of the correlation of the first signal s₁ with the second signal s₂, plotted in FIG. 7D provides an unbiased estimator of time delay τ. The width of this peak is a poor indication of the uncertainty in the time delay τ estimate, as shown by comparison with the posterior probability plotted in FIG. 7F.

FIG. 8 compares a histogram of time delay τ values corresponding to the peak of the envelope of the correlation curve from FIG. 7E with the posterior probability p(τ|s₁, s₂) from FIG. 7F. The histogram uses the peak of the envelope of the correlation function as an unbiased estimator of time delay τ. The histogram was derived from 10⁴ noise realizations. The true value of time delay τ is indicated as a vertical line. FIG. 8 shows that the posterior probability p(τ|\tilde{s}₁, \tilde{s}₂), as given by equation 15, is an accurate estimator of the uncertainty on time delay τ. The distribution of equation 15, which is created from a single realization of the noisy signals, contains the true value of time delay τ as a probable value and provides a good estimate of the uncertainty in time delay. The same enlarged time scale is used as in FIGS. 4 and 6 so that those figures can be compared with FIG. 8, which shows an increase in uncertainty that can be attributed to the degradation of information by the noise in s₂.

Illustrative embodiments of the present disclosure are also directed to methods for locating seismic events. An array V with M seismic receivers can be used to detect seismic waves produced by a seismic event. The signals from a seismic event are recorded on these receivers and indexed as S={s₁, s₂, . . . , s_{M}}. In some embodiments, the seismic source is a general point source (e.g., that can be represented as a moment-tensor and/or a simple directed force). The equations presented below can be used for an array of single-component receivers (e.g., pressure) recording arrivals from a single seismic phase. These expressions are then generalized to multi-component receivers and multiple phases.

In one embodiment, the travel-time delay formula given by equation 8 is applied to determine the location of a seismic source from an array of single-component receivers with respect to a single seismic phase and with known source initiation time. In this embodiment, each signal s₂ can be represented as:

\tilde{s}ⱼ=γⱼ\tilde{w}(τⱼ)+ñⱼ, (16)

in the Fourier domain, where w is a wavelet common to some or all receivers. The γⱼ coefficient allows the wavelet in the signal measured at each receiver to be independently distorted in both amplitude and phase. The time delay τⱼ for each receiver location corresponds to the travel time between the source and the receiver. These signals share the same time sampling, record the same time window, and possess a common time reference (e.g., their first time sample is synchronous with the source initiation time). The noise is assumed to be uncorrelated of the form nⱼ˜N(0, σⱼ²).

A seismic travel-time function Tⱼ(x) is used to compute the travel time for the seismic phase of interest from a hypothesized source location x to the j-th receiver location. In some embodiments, this seismic travel function is a velocity model for a subterranean formation. The velocity model represents at least the portion of the formation through which the seismic waves travel. The travel times may be computed by such means as a ray tracer or an eikonal solver. When a seismic source is located at x, the signal at the j-th receiver is then given by \tilde{s}ⱼ=γⱼ\tilde{w}Tⱼ(x))+ñⱼ. Given these simplifications, equation 8 can be applied to the source location problem by replacing time delay τ in equation 8 by Tⱼ(x), yielding:

$$p ( x \vert S ) = p ( x ) {\prod }_{j = 1}^{M} p ( x \vert {s}_{j} ) ∝ p ( x ) exp [ {‖ \tilde{w} ‖}^{- 2} {\sum }_{j = 1}^{M} {σ}_{j}^{- 2} {\vert {\overline{s}}_{j}^{H} \tilde{w} ( {T}_{j} ( x ) ) \vert}^{2} ] . \qquad ( 17 )$$

The first expression in equation 17 assumes that each signal provides independent information on the source location. The replacement of τⱼ by Tⱼ(x) implements a travel-time shift to each signal that will bring the waveforms into alignment when x equals the correct source location (given that the velocity model is correct). This serves as a probabilistic imaging condition for x being at the correct source location.

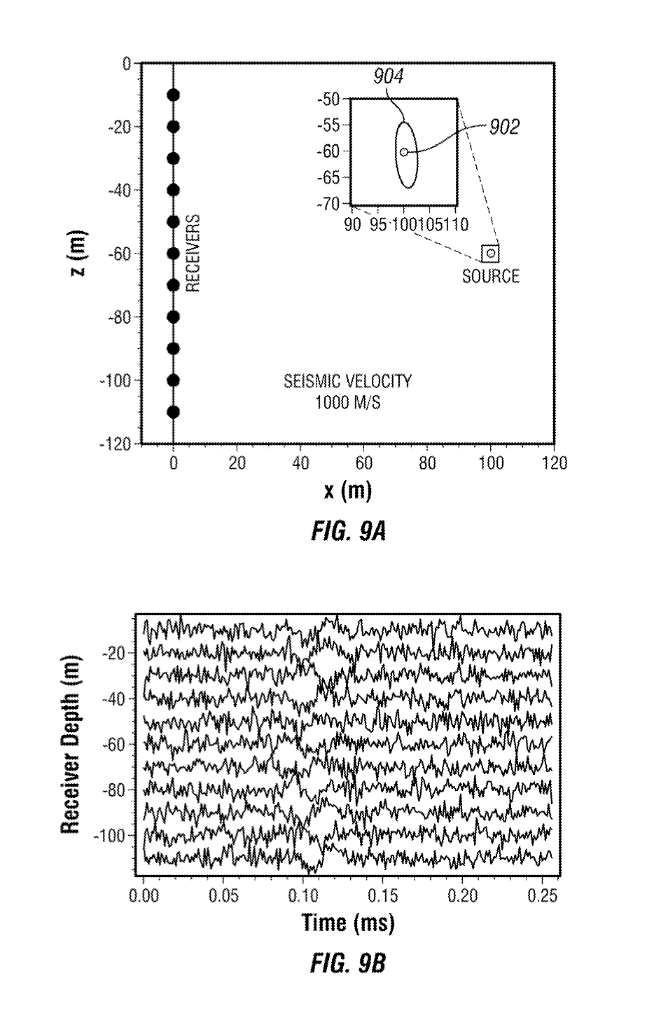

FIG. 9A shows a source location and associated confidence region that were determined using a posterior probability and known source initiation time. The Figure shows a system configuration with a source and an array of seismic receivers. The source is located at 100 m along the x-axis and −60 m along the z-axis. Eleven receivers are spaced at 10 m starting at a depth of −10 m. The velocity model for the configuration is homogeneous with a wave speed of 1000 m/s. The wavelet and noise statistics are the same as those in FIGS. 3A-3D. The signals were generated from equation 16, where the γⱼ have unit modulus and uniform random phase. FIG. 9B shows the signals received at each of the eleven seismic receivers. The posterior probability on source location was evaluated using equation 17 and the signals in FIG. 9B. Potential source locations were evaluated for a 51×51 grid of x values. The grid was centered at the true source location and has a spacing of 0.4 m. A uniform prior p(x) was used. The inset of FIG. 9A provides an enlargement of the 95 percent confidence region 904 for the source location with point 902 indicating the true source location. This inset shows vertical and horizontal resolutions of about 3 m and 1.5 m, respectively. The true source location lies within the probable region of the posterior pdf. It is clear that the location resolution is much better than the 33 m wavelength. Repeated experiments with different realizations of noise demonstrate an unbiased estimate of location.

In the description above, the source initiation time is treated as a known. In many seismic source location applications, however, the source initiation time is generally unknown. In such cases, even though the source initiation time t₀ is generally unknown, the initiation time will be the same for some or all of the received signals. Treating t₀ as a nuisance parameter, as in equation 6, the posterior estimator on location distribution given by equation 17 is revised to be joint in x and t₀, as p(x, l|S), which may then be marginalized to produce p(x|S):

$$p ( x \vert \tilde{S} ) = p ( x ) {\int }_{0}^{∞} {\prod }_{j = 1}^{M} p ( x , {t}_{0} \vert {\tilde{s}}_{j} ) d {t}_{0} ∝ p ( x ) {\int }_{0}^{∞} exp [ \frac{1}{{‖ \tilde{w} ‖}^{2}} {\sum }_{j = 1}^{M} {σ}_{j}^{- 2} {\vert {\tilde{s}}_{j}^{H} \tilde{w} ( {T}_{j} ( x ) + {t}_{0} ) \vert}^{2} ] d {t}_{0} . \qquad ( 18 )$$

Note that t₀ is defined relative to the time of the first sample in the signal vectors. The marginalization integral may be more rapidly evaluated in the time domain than in the frequency domain. In the time domain, the marginalization integral takes the form:

$$p ( x \vert S ) ∝ p ( x ) {\sum }_{{t}_{0} ∈ 𝒯} exp [ \frac{1}{2 {‖ w ‖}^{2}} {\sum }_{j = 1}^{M} {σ}_{j}^{- 2} {ɛ}^{2} [ {s}_{j} * w ( {T}_{j} ( x ) ) ] ( {t}_{0} ) ] , \qquad ( 19 )$$

where the periodicity of the discrete Fourier representation was used to convert the integral in equation 18 into a sum over the N time samples of the signals, collected in the set T={t₁, . . . , t_{N}}.

In other embodiments, the initiation time can be accounted for by optimization of a posterior probability function and/or optimization of a maximum likelihood function.

An advantage of evaluating |\tilde{s}₁^{H}\tilde{w}(τ)| in the time domain is that one application of the inverse FFT provides solutions for some or all values of time delay τ. With this approach, the envelope of the correlation is computed from:

ε[s₁*w(τ)]2\vec{N}|FFT⁻¹[\tilde{s}_{j*\textcircled{x}\tilde{w}}(τ)]|, (20)

where the superscript ‘*’ denotes the complex conjugate, \textcircled{x} denotes the componentwise multiplication of two vectors that produces a vector, and FFT⁻³ denotes the inverse FFT operating on both \tilde{s}ⱼ*\textcircled{x}\tilde{w}(τ) and its completion with zeros into the negative frequency domain.

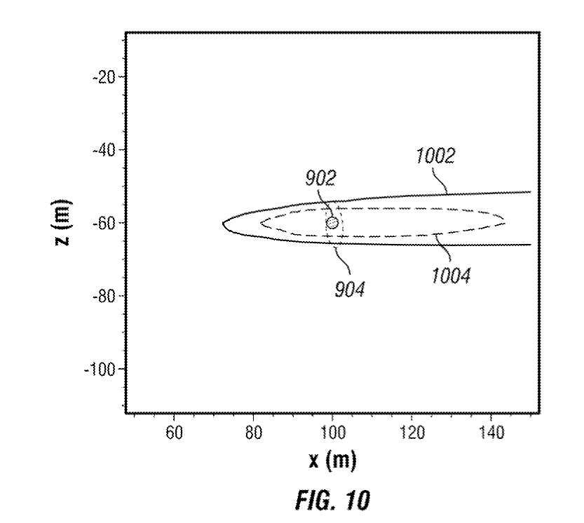

FIG. 10 shows a source location and associated confidence region that were determined using a posterior probability and an unknown source initiation time. The Figure was generated using the same data (e.g., the same noise realization) as in FIGS. 9A and 9B, but with an unknown source initiation time. A 0.05 s time offset was added to the signals to represent an unknown source initiation time. Equation 19 was applied to yield a 95 percent confidence region 1002. The 95 percent confidence region 904 from FIG. 9A and the true source location 902 are overlain for comparison. Comparing the two confidence regions, the depth resolution is largely unchanged, while the distance resolution is degraded by about an order of magnitude. Since distance resolution is largely due to the accuracy of measured arrival times in the system configuration, the knowledge of source initiation time has a large impact on distance resolution. Without the initiation time, distance resolution is controlled mostly by the impact of source distance on wave-field curvature measured at the receiver array, subject to the impact of noise on the ability to measure that curvature. In this example, the noise level is too high to measure curvature accurately enough to provide an accurate distance constraint. This conclusion is supported by 95 percent confidence region 1004, as shown in FIG. 10, in which the same noise realization is used, but with half the noise amplitude. In this case, the unknown source initiation time results in a smaller degradation of the distance resolution.

Illustrative embodiments of the present disclosure are also directed to methods for locating seismic events using multiple seismic phases. When multiple seismic phases are present and a multi-component receivers are used, equation 19 generalizes to:

$$p ( x \vert S ) ∝ p ( x ) {\sum }_{{t}_{0} ∈ 𝒯} exp [ \frac{1}{2 {‖ w ‖}^{2}} {\sum }_{a , j} {σ}_{a , j}^{- 2} {ɛ}^{2} [ {s}_{j} * w ( {T}_{a , j} ( x ) ) ] ( {t}_{0} ) ] , \qquad ( 21 )$$

where αε{P, S, . . . } indicates the seismic phase, and jε{1, . . . , M}. Since equation 21 is a product of the location probabilities for each receiver and phase, this equation remains valid in the case of missing data for particular phases and/or receivers. Missing data can be associated with a constant pdf for that particular phase and receiver, and thus the missing data does not impose a bias on the shape of the posterior pdf on location. Missing data will potentially decrease location resolution.

The signal s_{αj} corresponds to seismic phase α measured at receiver j. To obtain the signal for phase α, the seismic polarization direction vector for phase α at receiver j, denoted p_{α,j}(x), can be assumed to be known as a function of hypothesized source location x. The polarization vector p_{α,j} is the direction of particle motion for phase α at receiver j. p_{α,j} is normalized to unit length. The same ray tracer used to predict travel times T_{o,j}(x) might be used to predict these polarizations. The three components of the signal at each receiver location can be denoted as the N×3 matrix Uⱼ=[s_{1,j}, s_{2,j}, s_{3,j}], then the signal for phase α is approximated by s_{α,j}(x)=Uⱼp_{α,j}(x).

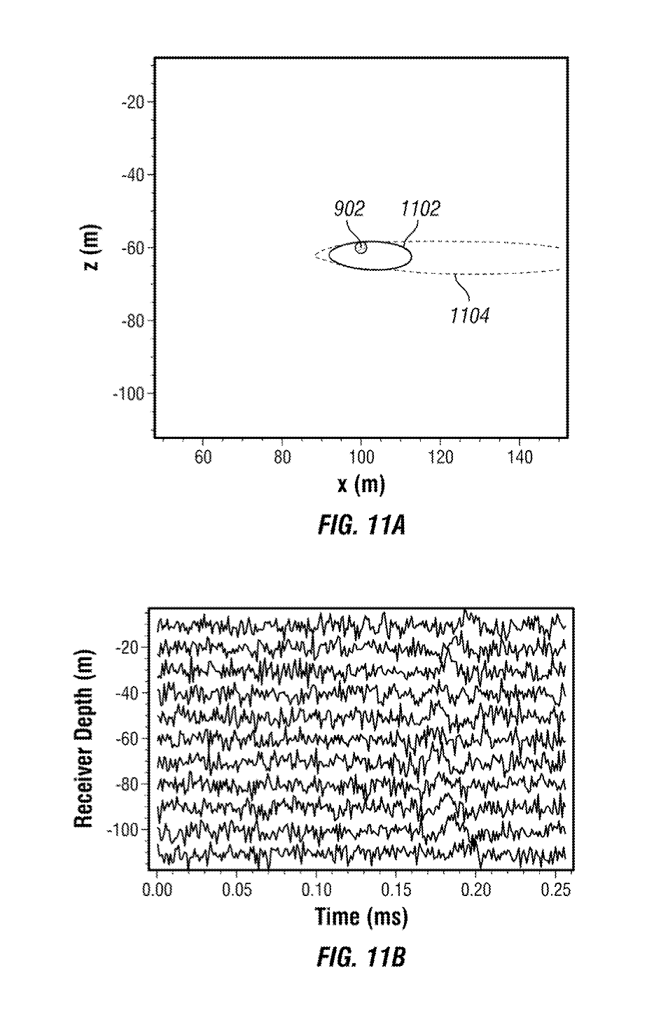

FIG. 11A shows a source location and associated confidence region that were determined using a posterior probability with unknown source initiation and multiple seismic phases. In this case, the system configuration used eleven two-component receivers measuring P-wave and S-wave arrivals. Otherwise, the Figure was generated using a similar system configuration to the one shown in FIG. 9A. FIG. 11B shows a vertical component of a signal received at each of the eleven two-component seismic receivers. The S-waves are visible at about 0.18 seconds, but the P-waves, at about 0.1 seconds, are obscured by noise. FIG. 11A shows the true source location 902, the 95 percent confidence region for the source location from both P-waves and S-waves 1102, and the 95 percent confidence region for S-wave-only localization 1104. A contour corresponding to only P-waves is omitted because the contour enclosed an area too large to appear in the Figure (due to the significantly reduced signal to noise ratio for P-waves in this example). The confidence regions were determined using equation 21, the signals received in FIG. 11B, and a homogeneous velocity model. Here the S-wave speed is taken as 577 m/s, and this phase has a polarization of vertically-polarized shear waves. The source was modeled by a vertical fracture with a sinusoidal radiation pattern that produces maximal P-wave energy in a vertical direction and maximal S-wave energy in a horizontal direction. Other than the sinusoidal radiation pattern, the amplitude and noise for both P-waves and S-waves are the same as in the example in FIG. 9A. Comparing confidence regions 1102 and 1104, when P-wave and S-wave signals are combined, there is a significant improvement in distance resolution, while the depth resolution remains similar to that from S-waves alone. The addition of P-wave data contributes significantly more information than just S-wave data alone, even though the low signal to noise ratio makes the P-waves difficult to identify in the signals. The improved resolution occurs because equation 21 uses information derived from the S-waves to guide the extraction of information from the P-waves.

Illustrative embodiments of the present disclosure are also directed to methods for locating seismic events using time delay between two wavelets at each receiver. For example, the time delay between a P-wave and S-wave at each receiver can be used to determine source location (“S-wave minus P-wave method”). As explained above, equation 15 provides the probability of a time delay τ with respect to two noisy signals: p(τ|s₁, s₂). In this embodiment, for each receiver, the time delays corresponding to the P-wave and S-wave travel times for a hypothesized source location are predicted and then the P-wave and S-wave signals are changed to undo those time delays. This will align the P-wave and S-wave if the hypothesized source location is correct (for a known velocity model). This method is similar to the correlation-based imaging condition commonly used in seismic migration imaging, but the method possesses the additional features that it is properly framed as a pdf, thus potentially providing increased resolution, and it marginalizes away the issues of amplitude and phase normalization. The resulting posterior pdf on source location is then given by:

$$p ( x \vert S ) = {\prod }_{j}^{M} p ( x \vert {\tilde{s}}_{P , j} , {\tilde{s}}_{S , j} ( {τ}_{j} ) ) ∝ 4 {π}^{2} p ( x ) {\prod }_{j}^{M} {\int }_{0}^{π / 2} exp [ - \frac{{cos}^{2} ( θ ) ‖ {\tilde{s}}_{P , j} {‖}^{2} + {sin}^{2} ( θ ) ‖ {\tilde{s}}_{S , j} {‖}^{2}}{{cos}^{2} ( θ ) {σ}_{P , j}^{2} + {sin}^{2} ( θ ) {σ}_{S , j}^{2}} ] \times {I}_{0} ( - \frac{sin ( 2 θ ) \vert {\tilde{s}}_{P , j}^{H} {\tilde{s}}_{S , j} ( {τ}_{j} ) \vert}{{cos}^{2} ( θ ) {σ}_{P , j}^{2} + {sin}^{2} ( θ ) {σ}_{S , j}^{2}} ) d θ , \qquad ( 22 )$$

where τⱼ=T_{P,j}(x)−T_{S,j}(x). In various embodiments, the source origin time is no longer a parameter, and thus the additional marginalization over origin time is avoided.

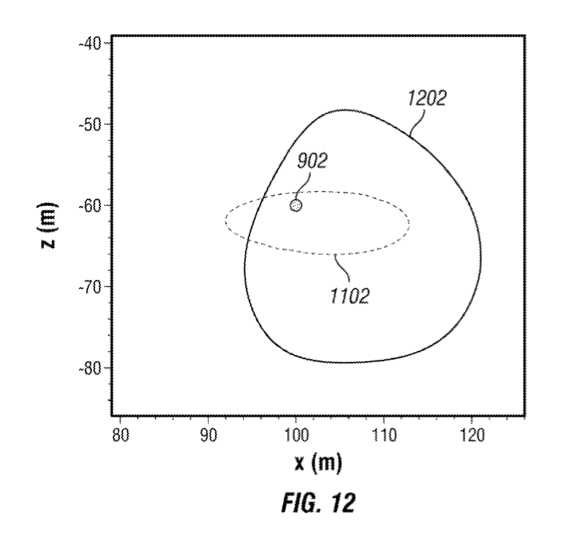

FIG. 12 shows a source location and associated confidence region that were determined using a posterior probability and time delay between S-waves and P-waves. The Figure was generated using the same system configuration and data (e.g., the same noise realization) as in FIGS. 11A and 11B. FIG. 12 shows the true source location 902, the 95 percent confidence region determined from equation 21 1102 (from FIG. 11A), and a 95 percent confidence interval determined using equation 22 1202. The true source location lies within the 95% confidence region of the uncertainty estimate. However, this 95% confidence region is larger than that computed from equation 21. This is because equation 21 enforces a common source initiation time for all receivers, while equation 22 enforces this condition on a receiver-by-receiver basis. The use of a common source initiation time imposes a strong constraint on source location, resulting in less uncertainty in the source location estimate.

Illustrative embodiments of the present disclosure are also directed to methods for locating seismic events using relative source location. Relative source location uses information from previously located sources to improve the location of another source. When relative locations are deduced from seismic arrival times that have been extracted from waveform data, the uncertainty in relative locations, due to both time-picking errors and velocity uncertainty, are reduced with respect to single-source location methods in which no reference sources are used. Further details regarding relative source location are provided in, for example, Oleg V. Poliannikov et al., A Unified Framework for Relative Source Localization using Correlograms, Geophysical Journal International, 194(1) pp. 557-571 (2013). Equation 23 below defines a likelihood function for a double-difference methodology that compares the arrival times from reference sources of known locations with those from another source of unknown location. In the past, relative source location used likelihood functions based on pairs of travel time differences. Equation 23 uses likelihood functions based on pairs of signals.

$$p ( \{ {τ}_{a , k , j} \} \vert x , {x}_{1} , … , {x}_{K} ) = {\prod }_{a , k , j} p ( {τ}_{a , k , j} \vert x , {x}_{K} ) . \qquad ( 23 )$$

The bracket notation indicates the set over-all index values. The notation τ_{α,k,j} refers to the measured arrival-time delay for seismic phase αε{P, S, . . . } at receiver jε{1, . . . , M} from source x and from the reference source xₖ (kε{1, . . . , K}) measured at the same receiver. The time delay is measured by finding the peak in the correlation between the pairs of signals, and the time delay is predicted through travel-time simulation from the formula:

τ_{α,k,j}=T_{α,j}(x)−T_{α,j}(xₖ)+Δtₖ. (24)

where Δtₖ is the time difference between the initiation times for the two sources. In principle, Δtₖ should also include the difference in origin times between the pair of signal vectors, but marginalizing over Δtₖ allows this aspect to be ignored without consequence.

The transformation of equation 23 into a waveform-based formula occurs by replacing p(τ_{α,k,j}|x, xₖ) with p(s_{α,j}, s_{α,k,j}|γ_{α,k,j}, x, xₖ), which is the likelihood of measuring the signal s, subject to the complex normalization factor γ_{α,k,j}. This likelihood has the same form as equation 10:

$$p ( {s}_{a , j} , {s}_{a , k , j} \vert {γ}_{a , k , j} , Δ {t}_{k} , x , {x}_{k} ) ∝ exp [ - \frac{{‖ {γ}_{a , j} {\overline{s}}_{a , j} - {γ}_{a , k , j} {\overline{s}}_{a , k , j} ( {τ}_{a , k , j} ) \vert ‖}^{2}}{\vert {γ}_{a , j} {\vert}^{2} {σ}_{a , j}^{2} + \vert {γ}_{a , k , j} {\vert}^{2} {σ}_{a , k , j}^{2}} ] , \qquad ( 25 )$$

where the predicted delay τ_{α,k,j} for location x is given by equation 24. Marginalizing over {γ_{α,j}}, {γ_{α,k,j}} and {Δtₖ}, using equation 15, and then applying Bayes' rule yields equation 26 for time-domain signals.

$$p ( x \vert \{ {\tilde{s}}_{a , j} \} , \{ {\tilde{s}}_{a , k , j} \} , \{ {x}_{k} \} ) ∝ 4 {π}^{2} p ( x ) {\prod }_{k} {\sum }_{Δ {t}_{k}} {\prod }_{a , j} {\int }_{0}^{π / 2} exp [ - \frac{{cos}^{2} ( θ ) ‖ {s}_{a , j} {‖}^{2} + {sin}^{2} ( θ ) ‖ {s}_{a , j , k} {‖}^{2}}{2 [ {cos}^{2} ( θ ) {σ}_{a , j}^{2} + {sin}^{2} ( θ ) {σ}_{a , j , k}^{2} ]} ] \times {I}_{0} ( \frac{sin ( 2 θ ) ɛ [ {s}_{a , j} * {s}_{a , j , k} ] ( {τ}_{a , k , j} )}{2 [ {cos}^{2} ( θ ) {σ}_{a , j}^{2} + {sin}^{2} ( θ ) {σ}_{a , j , k}^{2} ]} ) d θ \qquad ( 26 )$$

The sum over Δtₖ performs a marginalization over the nuisance parameters {Δtₖ}. This sum may be rapidly evaluated as in equation 19 by using the FFT.

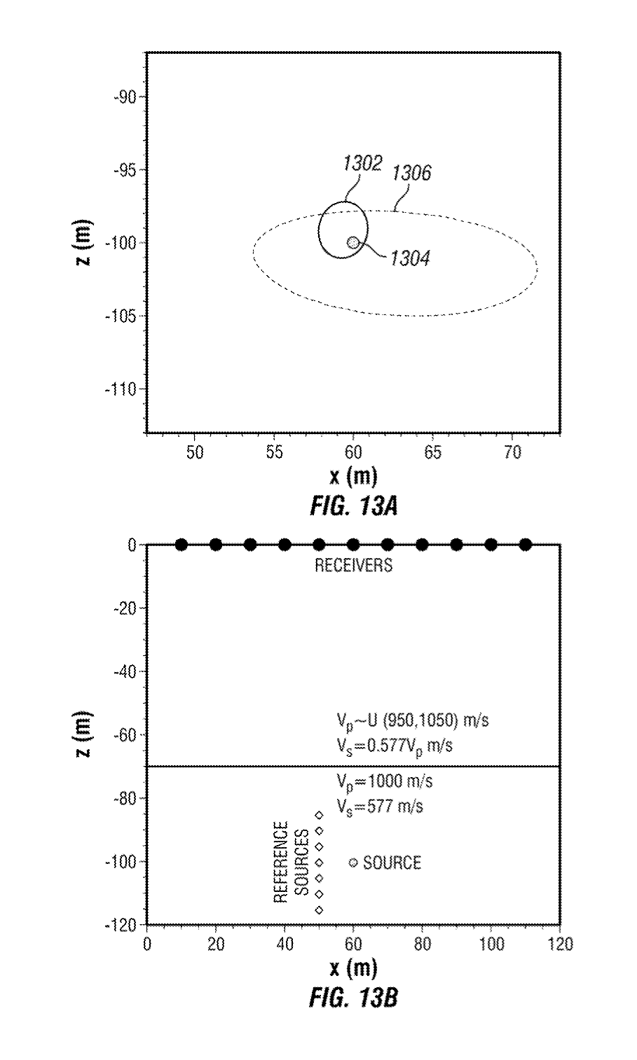

FIG. 13A shows a source location and an associated confidence region that were determined using relative source location. FIG. 13A was generated using equation 26 and a system configuration, as shown in FIG. 13B, which includes a two-layer model with eleven multicomponent receivers equally spaced at the surface (z=0 m). These results incorporate seven equally-spaced reference sources, with the same signal amplitudes, noise variance, and source radiation patterns as in FIGS. 11A and 11B. Although this relative location method is designed in part to mitigate location uncertainty due to uncertainty in the velocity model, in this example, a known velocity model is used. FIG. 13A shows a 95 percent confidence region 1302 and, for comparison, a true source location 1304 and the 95% confidence region for the S-wave minus P-wave method given in equation 22 1306. The S-wave minus P-wave method is a natural choice as a reference single-source method in this comparison because no wavelet estimation is needed for either method, as would be used in order to apply equation 21. Even in the absence of velocity uncertainty, the use of reference sources greatly improves the location estimate.

In another embodiment, a source location and an associated confidence region are determined using relative source location and an uncertain velocity model. When the velocity model is uncertain, following a distribution v˜p(v), and the location results for a given velocity model have the distribution p(x|v), then the velocity uncertainty can be marginalized away to obtain p(x).

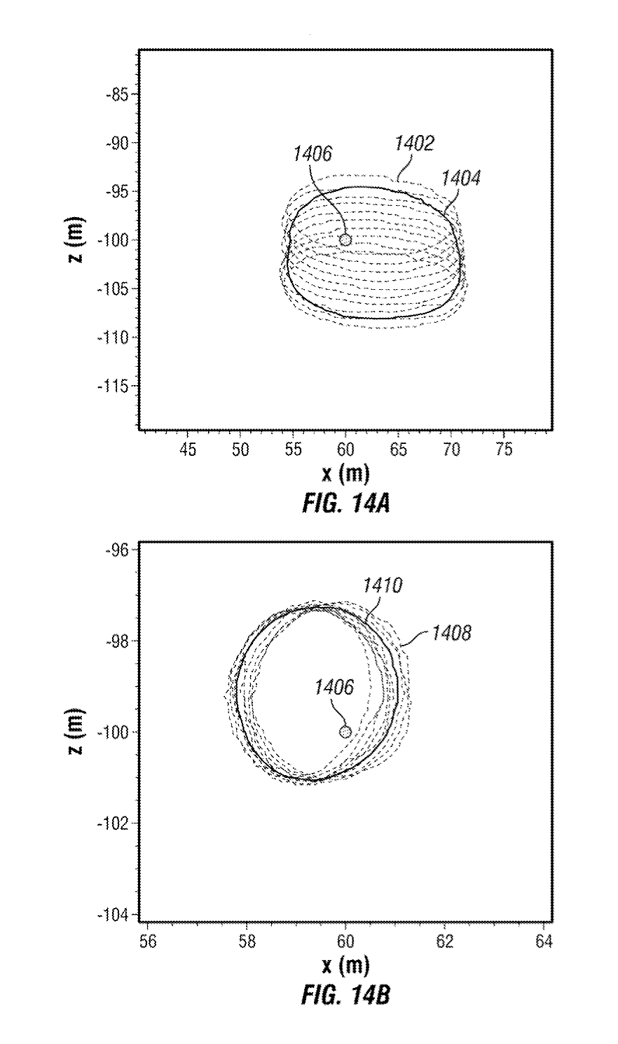

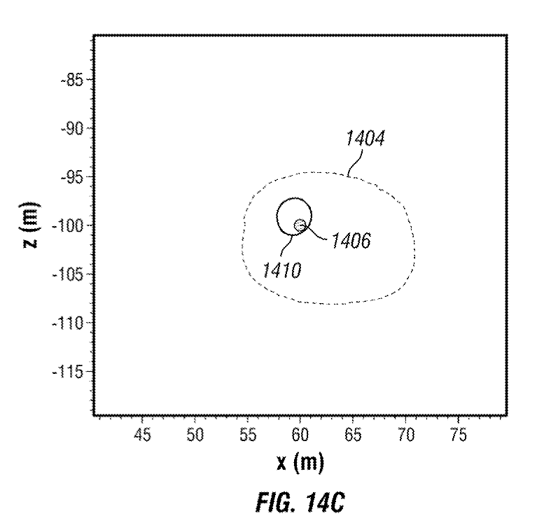

FIGS. 14A-14C compare a relative source location method to a S-wave minus P-wave method for a velocity model with 5 percent velocity uncertainty. The Figures were generated using the same system geometry and noise realization used in FIGS. 13A and 13B. Also, FIGS. 14A-14C were generated using a uniform distribution of P-wave velocity uncertainty v˜u(950,1050) and the S-wave velocity was computed as 1/\vec{3} times the P-wave velocity. FIG. 14A shows 95 percent confidence regions of p(x|vₙ) for ten homogeneous velocity models (whose errors uniformly span the range of −5% to 5%) for the S-wave minus P-wave method. The dashed contours 1402 indicate the confidence regions for each velocity model. The solid contour 1404 indicates a confidence region for the marginalized result and point 1406 shows the true source location. The dashed contours 1402 demonstrate the bias in location when only a single velocity model is considered. Marginalization removes this bias, with the consequence of a larger confidence region. FIG. 14B provides the equivalent illustration for relative source location. The bias is clearly reduced for each of the velocity models 1408, and the confidence region for each of these conditional estimates is significantly smaller than those in FIG. 14A. Consequently, the marginalized result 1410 has a significantly smaller confidence region than that of FIG. 14A. FIG. 14C shows a comparison between the 95 percent confidence regions for the S-wave minus P-wave method 1404 and the relative source location method 1410, showing a smaller confidence region for the relative location method.

The methods and systems described herein are not limited to any particular type of system arrangement. For example, the array of seismic receivers described herein can be deployed within a wellbore as part of a wellbore tool (e.g., a wireline tool). The array of seismic receivers can be deployed in a single monitoring wellbore or in a number of different monitoring wellbores. The seismic receivers can also be deployed at a surface location and/or in a treatment well.

Also, the methods and systems described herein are not limited to any particular type of application. For example, the methods can be used to monitor and spatially map fractures generated by a hydraulic fracturing operation, as shown in FIG. 2. Also, the methods and systems described herein can be used to map or localize seismic events that are induced by geothermal development, aquifer production, injected fluid-waste disposal, or earthquakes.

Illustrative embodiments of the present disclosure can be used to determine arrival time and associated uncertainty using seismic waves generated by either passive or active sources. Seismic waves have frequencies in a range between 3 Hz to 1000 Hz. The method described herein can also be used to analyze a subset of seismic waves. For example, the method can be used to analyze microseismic waves. Microseismic waves are seismic waves that are generated by small passive seismic events or small active sources, such as through fracture propagation.

The processes described herein, such as (i) receiving a seismic signal from a seismic receiver, (ii) using a Bayesian probability method to determine uncertainty in time delay for a wavelet in the seismic signal obtained from the seismic receiver, (iii) determining a probability for a seismic source location using uncertainty in time delay; (iv) determining a probability for a seismic source location using uncertainty in time delay between two or more wavelets, (v) determining a probability for seismic source location using relative source location, and (vi) spatially mapping fractures during a hydraulic fracturing operation, can be performed by a processing system.

Processes (i)-(vi), as listed above, can be performed at a variety of different locations. For example, in one embodiment, a processing system is located at the well site as part of the surface equipment (e.g., the truck 128 in FIG. 2). Processes (i)-(vi) are performed entirely at the well site using the processing system within the truck. The processing system acquires signal data from the wireline tool and uses the signal data to perform processes (i)-(vi). In some cases, these calculations may be performed in real-time at the well site. In another embodiment, processes (i)-(vi) are performed entirely at a location that is remote from the well site. For example, the processing system within the truck acquires the signal data and transmits the signal data over a communications network (e.g., a computer network) to a second processing system located at a remote location, such as an office building or a laboratory. The second processing system then performs processes (i)-(vi) using the signal data. In yet another embodiment, the processes (i)-(vi) are split between two different processing systems. For example, process (i) is performed at the well site by the processing system within the truck and then the results are communicated to the second processing system at the remote location. The second processing system then performs processes (ii)-(vi) using the results of process (i).

The term “processing system” should not be construed to limit the embodiments disclosed herein to any particular device type or system. The processing system may be a computer, such as a laptop computer, a desktop computer, or a mainframe computer. The processing system may include a graphical user interface (GUI) so that a user can interact with the processing system. The processing system may also include a processor (e.g., a microprocessor, microcontroller, digital signal processor, or general purpose computer) for executing any of the methods and processes described above (e.g. processes (i)-(vi)).

The processing system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. This memory may be used to store, for example, seismic signal data, formation data, velocity models, delay times, associated uncertainties, and fractures maps.

Any of the methods and processes described above, including processes (i)-(vi), as listed above, can be implemented as computer program logic for use with the processing system. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the processing system. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processing system may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

### APPENDIX A

\tilde{s}^{H}\tilde{w}(τ) can be represented as an analytical signal of time-domain correlation. This derivation is provided here in the continuous case for clarity of presentation, but applies also to the discrete case.

In the continuous case, \tilde{s}^{H}\tilde{w}(τ) is expressed as:

I(τ)=∫_{D}^{∞}s*(ω)w(ω)e^{1ωτ}dω, (27)

where the inner product is represented as an integral and the time shift appears as a complex phase. Making the change of variable, ω=−ω′, yields:

$$\begin{matrix}I ( τ ) = {\int }_{- ∞}^{0} {s}^{*} ( - {ω}^{′} ) w ( - {ω}^{′} ) {e}^{- {iω}^{′} τ} d {ω}^{′} \\ = {\int }_{- ∞}^{0} s ( {ω}^{′} ) {w}^{*} ( {ω}^{′} ) {e}^{- {iω}^{′} τ} d {ω}^{′} ,\end{matrix} \qquad ( 28 )$$

where use of the equivalences s(−ω)=s*(ω) and ω(−ω)=w*(ω) apply for real time-domain signals. Consequently, from the second expression in equation 28, the following relationship is derived:

I*(τ)=∫_{-∞}⁰s*(ω)w(ω)e^{1ωτ}dω, (29)

which when combined with equation 27 yields:

I(τ)+I*(τ)=2Re(I(τ))=∫_{-∞}^{∞}s*(ω)w(ω)e^{1ωτ}dω (30)

and

I(τ)−I*(τ)=2iIm(I(τ))=∫_{-∞}^{∞}Sgn(ω)s*(ω)w(ω)e^{1ωτ}dω (31)

where Sgn(ω) is the sign function that is −1 for negative _{w}, and 1 otherwise. Recognizing that the Hilbert transform of a time-domain function ƒ(t) is defined in the frequency domain as 1Sgn(ω)ƒ(ω), and that the inverse Fourier transform of s* (ω)w(ω) is the correlation function [s*w](τ), equation 30 and equation 31 may be summed to yield:

2I(τ)=[s*w](τ)− [symbol] [s*w](τ), (32)

where [symbol] (•) denotes the Hilbert transform. Noting that the right-hand side of equation 32 is the definition of the analytic signal of s*w, produces the result:

I=½ [symbol] [s*w](τ), (33)

where [symbol] (•) denotes the analytic signal. Thus, in its discrete representation,

\tilde{s}^{H}\tilde{w}(τ)=½ [symbol] [s*w](τ), (34)

The magnitude of this quantity can be expressed in terms of the signal envelope as:

|\tilde{s}^{H}\tilde{w}(τ)|=½ε[s*w](τ), (35)

where ε(•) denotes the signal envelope.

What is claimed is:

1. A method for analyzing a wavelet within a seismic signal, the method comprising:
using a Bayesian probability method to determine an arrival time for a wavelet in a seismic signal obtained from a seismic receiver and to determine an uncertainty for the arrival time.

2. The method of claim 1, wherein the uncertainty in the arrival time for the wavelet is determined using a posterior probability.

3. The method of claim 2, wherein the posterior probability is a probability of the arrival time given the seismic signal.

4. The method of claim 3, wherein the wavelet is represented as a reference wavelet shifted in time by a time delay.

5. The method of claim 4, wherein the reference wavelet is measured.

6. The method of claim 4, wherein the wavelet is represented as the reference wavelet multiplied by a constant.

7. The method of claim 6, wherein the constant is representative of distortion in both amplitude and phase of the reference wavelet.

8. The method of claim 6, wherein the constant is accounted for using at least one of (i) probabilistic marginalization, (ii) optimization of a posterior probability function, and (iii) optimization of a maximum likelihood function.

9. The method of claim 1, wherein determining uncertainty in the arrival time comprises determining uncertainty in time delay between (i) a first wavelet within a first seismic signal obtained from the seismic receiver and (ii) a second wavelet within a second seismic signal obtained from the seismic receiver.

10. The method of claim 9, wherein the first wavelet is represented by a reference wavelet and the second wavelet is represented by the reference wavelet multiplied by a constant and shifted in time by the time delay.

11. The method of claim 10, wherein the uncertainty in the time delay is determined using a posterior probability and the posterior probability is a probability of the time delay given the first seismic signal and the second seismic signal.

12. The method of claim 10, wherein the constant is representative of distortion in both amplitude and phase of the reference wavelet.

13. The method of claim 12, wherein the constant is accounted for using at least one of (i) probabilistic marginalization, (ii) optimization of a posterior probability function, and (iii) optimization of a maximum likelihood function.

14. The method of claim 1, further comprising:
using the Bayesian probability method to determine uncertainty in arrival time for each of a plurality of wavelets within a plurality of seismic signals obtained from a plurality of seismic receivers; and
determining a probability for location of a seismic source using uncertainty in arrival time for each of the plurality of wavelets.

15. The method of claim 14, wherein determining the probability for the seismic source location comprises determining probabilities for a plurality of potential locations for the seismic source.

16. The method of claim 14, wherein determining the probability for the seismic source location comprises using a seismic travel-time function that determines travel time for each wavelet from a potential seismic source location to a seismic receiver.

17. The method of claim 16, wherein a condition for determining the probability of a potential source location is that the wavelets align at a correct seismic source location.

18. The method of claim 17, wherein the seismic travel-time function uses a velocity model for a subterranean formation.

19. The method of claim 17, wherein an initiation time for the seismic source is unknown and the initiation time is accounted for using at least one of (i) probabilistic marginalization, (ii) optimization of a posterior probability function, and (iii) optimization of a maximum likelihood function.

20. The method of claim 1, further comprising:
using the Bayesian probability method to determine (i) uncertainty in arrival time for a first wavelet within the seismic signal obtained from the seismic receiver and (ii) uncertainty in arrival time for a second wavelet within the seismic signal obtained from the seismic receiver; and
determining a probability for location of a seismic source using uncertainty in time delay between the arrival time for the first wavelet and the arrival time for the second wavelet.

21. The method of claim 20, wherein the first wavelet is representative of a P-wave and the second wavelet is representative of an S-wave.

22. The method of claim 21, wherein determining the probability for the seismic source location comprises determining probabilities for a plurality of potential locations for the seismic source.

23. The method of claim 21, wherein determining the probability for the seismic source location comprises using a seismic travel-time function that determines (i) travel time for the P-wave from a potential seismic source location to the seismic receiver and (ii) travel time for the S-wave from a potential seismic source location to the seismic receiver.

24. The method of claim 23, wherein a condition for determining the probability of a potential source location is that the P-wave and the S-wave align at a correct seismic source location.

25. The method of claim 1, further comprising:
using the Bayesian probability method to determine uncertainty in arrival time for a first wavelet and uncertainty in arrival time for a second wavelet within a seismic signal obtained from a seismic receiver, wherein the first wavelet is generated by a first seismic source with a known location and the second wavelet is generated using a seismic source with an unknown location; and
determining a probability for a location of the second seismic source using uncertainty in time delay between the arrival time for the first wavelet and the arrival time for the second wavelet.

26. The method of claim 25, wherein determining the probability for the second seismic source location comprises determining probabilities for a plurality of potential locations for the second seismic source.

27. The method of claim 26, wherein determining the probability for the second seismic source location comprises using a seismic travel-time function that determines travel time for the second wavelet from a potential second seismic source location to the seismic receiver.

28. The method of claim 1, wherein the seismic signal is a microseismic signal.

29. The method of claim 1, further comprising:
using the Bayesian probability method to determine uncertainty in time delay for a plurality of wavelets in a plurality of seismic signals obtained from a plurality of seismic receivers;
using the uncertainty in time delay for the plurality of wavelets to determine locations for a plurality of seismic sources and associated uncertainties; and
using the locations for the plurality of seismic sources to spatially map fractures during a hydraulic fracturing operation.

30. The method of claim 1, wherein the wavelet is at least one of a P-wave arrival and an S-wave arrival.

31. A system for analyzing a wavelet in a seismic signal, the system comprising:
a processing system configured to (i) receive a seismic signal and (ii) use a Bayesian probability method to determine uncertainty in arrival time for a wavelet in the seismic signal.

32. The system of claim 31, further comprising:
a plurality of seismic receivers deployed within a wellbore and configured to receive seismic waves that travel through the formation to the wellbore.

33. The system of claim 31, further comprising:
a plurality of seismic receivers deployed at a surface location and configured to receive seismic waves that travel through the formation to the surface.

34. The system of claim 31, wherein the uncertainty in the time delay for the wavelet is determined using a posterior probability of the time delay given the seismic signal.

35. The system of claim 34, wherein the wavelet is represented as a reference wavelet multiplied by a constant and shifted in time by the time delay.

36. The method of claim 35, wherein the constant is representative of distortion in both amplitude and phase of the reference wavelet.

37. A non-transitory computer readable medium encoded with instructions, which, when loaded on a computer, establish processes for analyzing a wavelet in a seismic signal, the processes comprising:
using a Bayesian probability method to determine uncertainty in arrival time for a wavelet in the seismic signal.

38. The non-transitory computer readable medium of claim 37, wherein the uncertainty in the time delay for the wavelet is determined using a posterior probability of the time delay given the seismic signal.

39. The non-transitory computer readable medium of claim 38, wherein the wavelet is represented as a reference wavelet multiplied by a constant and shifted in time by the time delay.

40. The non-transitory computer readable medium of claim 39, wherein the constant is representative of distortion in both amplitude and phase of the reference wavelet.
